(19) United States
(12) Patent Application Publication
(10) Pub. No.: US 2025/0181506 A1
(43) Pub. Date: Jun. 5, 2025

(54) CACHE SNOOP REPLAY MANAGEMENT

(71) Applicant: Akeana, Inc., Santa Clara, CA (US)

(72) Inventor: Sanjay Patel, San Ramon, CA (US)

(73) Assignee: Akeana, Inc., Santa Clara, CA (US)

(21) Appl. No.: 18/966,200

(22) Filed: Dec. 3, 2024

Related U.S. Application Data
(60) Provisional application No. 63/702,192, filed on Oct. 2, 2024.
(60) Provisional application No. 63/699,245, filed on Sep. 26, 2024.
(60) Provisional application No. 63/691,351, filed on Sep. 6, 2024.
(60) Provisional application No. 63/690,822, filed on Sep. 5, 2024.
(60) Provisional application No. 63/687,795, filed on Aug. 28, 2024.
(60) Provisional application No. 63/679,685, filed on Aug. 6, 2024.
(60) Provisional application No. 63/679,192, filed on Aug. 5, 2024.
(60) Provisional application No. 63/653,402, filed on May 30, 2024.
(60) Provisional application No. 63/640,921, filed on May 1, 2024.
(60) Provisional application No. 63/641,045, filed on May 1, 2024.
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/556,944, filed on Feb. 23, 2024.
(60) Provisional application No. 63/556,951, filed on Feb. 23, 2024.
(60) Provisional application No. 63/605,620, filed on Dec. 4, 2023.
(60) Provisional application No. 63/714,529, filed on Oct. 31, 2024.
(60) Provisional application No. 63/719,841, filed on Nov. 13, 2024.

(51) Int. Cl. G06F 12/0831; G06F 12/084; G06F 12/0891

(52) U.S. Cl. CPC G06F 12/0831; G06F 12/084; G06F 12/0891

(57) ABSTRACT

Cache management techniques are disclosed. A plurality of processor cores is accessed. Each processor core includes a shared local cache. The shared local cache supports snoop operations. A snoop queue is coupled to the plurality of processor cores. The snoop queue is shared among the plurality of processor cores. Two or more snoop operations are received for the shared local cache. The two or more snoop operations point to a common cache-line physical address within the shared local cache. The two or more snoop operations are enqueued in the snoop queue. A snoop response is generated to a first snoop operation of the two or more snoop operations. A cache eviction operation is prevented from completing, based on the snoop response being completed with a positive cache-line physical address comparison. The cache-line physical address comparison comprises a partial cache-line physical address comparison.

### RELATED APPLICATIONS

This application claims the benefit of U.S. provisional patent applications “Cache Snoop Replay Management” Ser. No. 63/605,620, filed Dec. 4, 2023, “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563, 102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, and “Vector Floating-Point Flag Update With Micro-Operations” Ser. No. 63/719,841, filed Nov. 13, 2024.

Each of the foregoing applications is hereby incorporated by reference in its entirety.

### FIELD OF ART

This application relates generally to cache management and more particularly to cache snoop replay management.

### BACKGROUND

Many have argued that modern society operates using a wide variety of electronic devices. The most essential of the electronic devices are those based on computer processors. The computer processors are essential across a wide range of industries and applications. The processors provide power to computers, laptops, tablets, and smartphones, and enable people to perform various tasks such as browsing the Internet, running applications, processing data, and communicating with others. Processors have revolutionized how people work, play, communicate, access information, and are entertained. Computer processors are fundamental to the growth of the Internet of Things. Processors are embedded in smart devices, sensors, and appliances to enable interconnectivity and data processing. Processors allow IoT and other devices to collect, analyze, and transmit data, enabling the automation, remote monitoring, and control of various systems including smart homes, industrial automation, healthcare devices, vehicles, and more. Processors are key components in communication and networking technologies. Processors are found in routers, switches, and modems, where they facilitate data transmission and network management. Processors are also used in telecommunications infrastructure, mobile network equipment, and wireless devices, providing seamless connectivity and communication.

The main categories of processors include Complex Instruction Set Computer (CISC) types, and Reduced Instruction Set Computer (RISC) types. In a CISC processor, one instruction may execute several operations. The operations can include memory storage, loading from memory, an arithmetic or logic operation, and so on. In contrast, in a RISC processor, the instruction sets tend to be smaller than the instruction sets of CISC processors and may be executed in a pipelined manner. The pipeline stages can include fetch, decode, and execute. Each of these pipeline stages may take one clock cycle, and thus, the pipelined operation can allow RISC processors to operate on more than one instruction per clock cycle.

Electronic devices, based on integrated circuits (ICs), are designed using a Hardware Description Language (HDL). Examples of such languages can include Verilog, VHDL, etc. HDLs enable the various descriptions including system behavioral, register transfer, gate level, and switch level logic. The languages provide designers with the ability to define system levels in detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool, which in turn creates the gate-level abstraction of the design that is used for downstream implementation operations.

### SUMMARY

Whether the operations performed by the processor cores are substantially similar or not, managing how processor cores access data is critical to successfully processing the data. Since the processor cores can operate on data in shared storage such as a common memory structure, and on copies of the common memory data loaded into local caches, data coherency must be maintained between the common storage and the local caches. Thus, when changes are made to a copy of the data, the changes must be propagated to all other copies of the data and to the common memory. Before propagating or promoting changes of the data to the common memory, write operations, herein referred to as cache eviction operations, are compared to determine whether the writes access a substantially similar cache-line physical address. The comparing is accomplished by comparing cache-line physical addresses. The comparing is accomplished by comparing a cache-line physical address couplet to a snoop request physical address couplet. The cache-line physical address couplet comprises a set-index field concatenated to a set-way field. The cache-line physical address couplet comprises a constant value for a cache line that is being snooped. A cache eviction operation is prevented from completing, based on the snoop response being completed with a positive cache-line physical address comparison. The cache-line physical address comparison comprises a partial cache-line physical address comparison. By contrast, the cache eviction operation is allowed to complete, based on the snoop response being completed with a negative cache-line physical address comparison.

Cache management techniques are disclosed. A plurality of processor cores is accessed. Each processor core includes a shared local cache. The shared local cache supports snoop operations. A snoop queue is coupled to the plurality of processor cores. The snoop queue is shared among the plurality of processor cores. Two or more snoop operations are received for the shared local cache. The two or more snoop operations point to a common cache-line physical address within the shared local cache. The two or more snoop operations are enqueued in the snoop queue. A snoop response is generated to a first snoop operation of the two or more snoop operations. A cache eviction operation is prevented from completing, based on the snoop response being completed with a positive cache-line physical address comparison. The cache-line physical address comparison comprises a partial cache-line physical address comparison.

A processor-implemented method for cache management is disclosed comprising: accessing a plurality of processor cores, wherein each processor of the plurality of processor cores includes a shared local cache, and wherein the shared local cache supports snoop operations; coupling a snoop queue to the plurality of processor cores, wherein the snoop queue is shared among the plurality of processor cores; receiving two or more snoop operations for the shared local cache, wherein the two or more snoop operations point to a common cache-line physical address within the shared local cache, and wherein the two or more snoop operations are enqueued in the snoop queue; generating a snoop response to a first snoop operation of the two or more snoop operations; and preventing a cache eviction operation from completing, based on the snoop response being completed with a positive cache-line physical address comparison, wherein the cache-line physical address comparison comprises a partial cache-line physical address comparison. In embodiments, the partial cache-line physical address comparison is performed between a cache-line aligned physical address of the cache eviction operation and all cache-line aligned physical addresses of outstanding snoop entries in the snoop queue. In embodiments, a directory includes a snoop bit for each of the snoop entries. In embodiments, the snoop bit is set based on a pending cache-line snoop operation in the snoop queue. In embodiments, the snoop bit is cleared based on a last snoop replay for a pending cache-line snoop operation in the snoop queue.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for cache snoop replay management.

FIG. 2 is a flow diagram for shared local cache usage.

FIG. 3 is a system block diagram showing snoop replay management.

FIG. 4 is a block diagram illustrating a RISC-V™ processor.

FIG. 5 is a block diagram for a pipeline.

FIG. 6 is a system block diagram illustrating processor cores with cache management.

FIG. 7 is a system block diagram showing a compute coherency block (CCB).

FIG. 8 is a system diagram for cache snoop replay management.

### DETAILED DESCRIPTION

Individuals worldwide interact daily with a dizzying variety of electronic devices. These electronic devices can provide wide-ranging features such as large or small, stationary or portable, powerful or simple, or handheld, among others. Popular electronic devices include personal electronic devices such as computers, handheld electronic devices such as smartphones and tablets, and smartwatches. The electronic devices are also present in household devices including kitchen and cleaning appliances; personal, private, and mass transportation vehicles; and medical equipment; among many other familiar devices. Each of these devices is constructed with at least one type, and often many types, of integrated circuits or chips. The chips enable required, useful, and desirable device features by performing processing and control tasks. Electronic processors enable the devices to execute a typically vast range and number of applications. The applications include data processing; entertainment; messaging; patient monitoring; telephony; and vehicle access, configuration, and operation control; etc. Additional electronic elements can be coupled to the processors in higher-function chips such as system-on-a-chip (SOC) devices. The SOCs enable features and application execution. The additional elements typically include one or more of memories, radios, networking channels, peripherals, touch screens, battery and power controllers, and so on.

Blocks or portions of contents such as data within a shared or a common memory can be moved to local cache memory. The data is moved to boost processor performance. The local cache memory is smaller, faster, and located in closer proximity to the processor in comparison to the shared memory. The local cache is shared between processors, thereby enabling local data exchange between the processors. The use of local cache memory is computationally advantageous because using the cache takes advantage of “locality” of instructions and data. Such instruction and data locality are typically present in application code as the code is executed by the processors. Coupling the cache memory to processors drastically reduces memory access times because of the adjacency of the instructions and the data. A processor accesses the instructions and the data locally. This access is accomplished without the need to send a request across a common bus, across a crossbar switch, through various buffers, and so on to access the instructions and data. Similarly, the processor does not experience the delays associated with the shared bus contention, buffer delays, crossbar switch transit times, etc. The cache memory can be accessed by one, some, or all of a plurality of processors without having to access the slower common memory, thereby reducing access time and increasing processing efficiency. However, the use of smaller cache memory dictates that new cache lines must be brought into the cache memory to replace no-longer-needed cache lines (called a cache miss, which requires a cache line fill), and that existing cache lines in the cache memory that are no longer synchronized (coherent) must be evicted and managed across all caches and the common memory. The evicting cache lines and filling cache lines is accomplished using cache management techniques.

In disclosed techniques, the cache management issues are addressed by cache snoop replay management. The cache snoop replay management can be applied to a compute coherency block (CCB). A compute coherency block can include a plurality of processor cores, shared local caches coupled to groupings of processor cores, shared intermediate caches, a shared system memory, and so on. Each processor core includes a shared local cache. The shared local cache can be used to store cache lines, blocks of cache lines, etc. The cache lines and blocks of cache lines can be loaded from memory such as a shared system memory. Each local processor core can process cache lines within the local cache, based on operations performed by the processor cores. If a processor writes or stores data to the shared local cache, the data becomes “dirty”. That is, the data in the local cache is different from the data in the shared memory system, the intermediate cache (if present), and other local caches. In order to maintain coherency across a compute coherency block, snoop operations and responses to the snoop operations are generated. A snoop response can determine whether there is a positive cache-line physical address comparison or a negative comparison. A positive address comparison can prevent a cache eviction operation from completing, thereby leaving in place the cache line associated with the eviction operation. A negative address comparison can allow the eviction operation to complete.

A snoop operation, or snoop request, can be supported within the CCB. Snoop operations can seek a cache line within shared local caches; in a shared, hierarchical cache; and in shared, common memory. The seeking can result from cache misses to the local cache. The common memory can be coupled to the multiple CCB caches using Network-on-Chip (NoC) technology. The snoop operations can be used to determine whether data access operations being performed by more than one processor core access the same memory address in one or more caches or the shared common memory. Cache lines are evicted from local caches by an eviction operation. The snoop operations can be used to determine whether cache lines for eviction can be committed to storage in the common memory without overwriting data already in the common memory that is required by another processor. The snoop requests can further monitor transactions such as data reads from and data writes to the common memory. While read operations leave data contained within a cache or the common memory unchanged, a write operation to a cache or to the common memory can change data. As a result, the copy of the data within a cache can become “incoherent” or “dirty” with respect to the common memory. The incoherence can be either due to changes to the cache contents or changes to the common memory contents. The data changes, if not monitored and corrected using coherency management techniques, result in cache coherency hazards. That is, new data can overwrite old data before the old data is used, old data is read before new data can be written, etc.

Cache management is enabled by cache evict duplication management. A plurality of processor cores is accessed, wherein each processor of the plurality of processor cores includes a shared local cache, and wherein the plurality of processor cores implements special cache coherency operations. An evict buffer is coupled to the plurality of processor cores, wherein the evict buffer is shared among the plurality of processor cores, and wherein the evict buffer enables delayed writes. Evict buffer writes are monitored, wherein the monitoring evict buffer writes identifies a special cache coherency operation. An evict buffer entry is marked, wherein the marking corresponds to the special cache coherency operation that was identified, and wherein the marking enables management of cache evict duplication.

Techniques for cache management using cache snoop replay management are described. The cache management can maintain cache line validity and cache coherency among groupings of one or more processor cores, local caches coupled to each processor core, a local cache shared with the processor core grouping, common memories, shared caches, and so on. The processor cores can be used to accomplish a variety of data processing tasks. A processor core can include a standalone processor, a processor chip, a multi-core processor, and the like. The processing of data can be significantly enhanced by using two or more processor cores (e.g., parallel processors) to process the data. The processor cores can be performing substantially similar operations, where the processor cores can process different portions or blocks of data in parallel. The processor cores can be performing substantially different operations, where the processor cores can process different blocks of data or may try to perform different operations on the same data. Whether the operations performed by the processor cores are substantially similar or not, managing how processor cores access data is critical to successfully processing the data. Since the processor cores can operate on data in shared storage such as a common memory structure, and on copies of the common memory data loaded into local caches, data coherency must be maintained between the common storage and the local caches. Thus, when changes are made to a copy of the data, the changes must be propagated to all other copies of the data and to the common memory. Before propagating or promoting changes of the data to the common memory, write operations, herein referred to as cache eviction operations, are compared to determine whether the writes access a substantially similar cache-line physical address. The comparing is accomplished by comparing cache-line physical addresses. The comparing is accomplished by comparing a cache-line physical address couplet to a snoop request physical address couplet. The cache-line physical address couplet comprises a set-index field concatenated to a set-way field. The cache-line physical address couplet comprises a constant value for a cache line that is being snooped. A cache eviction operation is prevented from completing, based on the snoop response being completed with a positive cache-line physical address comparison. The cache-line physical address comparison comprises a partial cache-line physical address comparison. By contrast, the cache eviction operation is allowed to complete, based on the snoop response being completed with a negative cache-line physical address comparison.

The execution rate of data processing operations such as those associated with large datasets, large numbers of similar processing jobs, and so on can be increased by using one or more local or “cache” memories. A cache memory can be used to store a local copy of the data to be processed, thereby making the data easily accessible. A cache memory, which by design is typically smaller and has much lower access times than a shared, common memory, can be coupled between the common memory and the processor cores. Further, each processor core can include a local cache, thereby adding additional storage in which copies of the data can be stored. As the processor cores process data, they search first within the cache memory for an address containing the data. If the address is not present within the cache, then a “cache miss” occurs, and the data requested by the processor cores can be obtained from an address within one or more higher levels of cache. If a cache miss occurs with the higher-level caches, then the requested data can be obtained from the address in the common memory. Data access by one or more processors using the cache memory is highly preferable to accessing common memory because of reduced latency associated with accessing the local cache memory as opposed to the remote common memory. The advantage of accessing data within the cache is further enhanced by the “locality of reference”. The locality of reference indicates that code that is being executed tends to access a substantially similar set of memory addresses. The locality of reference can apply whether the memory addresses are located in the common memory, a higher-level cache, or the local cache memory. By loading the contents of a set of common memory addresses into the cache, the processor cores are, for a number of cycles, more likely to find the requested data within the cache. As a result, the processor cores can obtain the requested data faster from the cache than if the requested data were obtained from the common memory. However, due to the smaller size of the cache with respect to the common memory, a cache miss can occur when the requested memory address is not present within the cache. One cache replacement technique that can be implemented loads a new block of data from the common memory into the local cache memory, where the new block contains one or more cache lines, and where a cache line can include the requested address. Thus, after the one or more cache lines are transferred to the cache, processing can again continue by accessing the faster cache rather than the slower common memory.

The processor cores can read a copy of data from a memory such as a cache memory, process the data, and then write the processed data back to the cache. As a result of the processing, the contents of the cache can be different from the contents of other caches and of the common memory. Cache management techniques can be used to keep the state of the data in the common memory and the shared data in the one or more shared caches or local caches “in sync” or coherent. A complementary problem can occur when out-of-date data remains in the cache after the contents of the common memory are updated. As before, this data state discrepancy can be remedied using cache management techniques that can make the data coherent. In embodiments, additional local caches can be coupled to processors, groupings of processors, etc. While the additional local caches can greatly increase processing speed, the additional caches further complicate cache management. Techniques presented herein address cache management in general, and cache snoop replay management in particular, between shared local caches and additional shared memory. The additional shared memory can include intermediate caches, shared system memory, and the like. The presented techniques further address snoop operations received for a shared local cache. The two or more snoop operations can be compared for cache-line physical address access. The cache-line physical address comparison can include a positive comparison or a negative comparison. A positive cache-line physical address comparison can prevent a cache eviction operation from completing, while a negative cache-line physical address comparison can allow a cache eviction operation to complete. The allowing the cache eviction operation can be based on the common cache-line physical address being overwritten in the shared local cache.

Snoop operations, which can be based on access operations such as write operations generated by processor cores, can be used to determine whether a difference exists between data in the common memory and data in the one or more shared local caches. If differences are detected, then a cache maintenance operation can resynchronize the data between the common memory and the one or more caches. The cache maintenance operations can be based on transferring cache lines between the compute coherency block cache and the shared common memory, or between the compute coherency block cache and other compute coherency block caches. The transferring can be accomplished using a bus interface unit. The bus interface can provide access to the common memory. In addition to transfers from the common memory to local caches and shared caches based on cache misses, cache transfers can also occur from the local caches and the shared caches to the common memory as a result of changes performed by the processor cores to the cache contents. The updated or “dirty” cache contents can be transferred to the common memory and can be copied to other caches in order to maintain coherency.

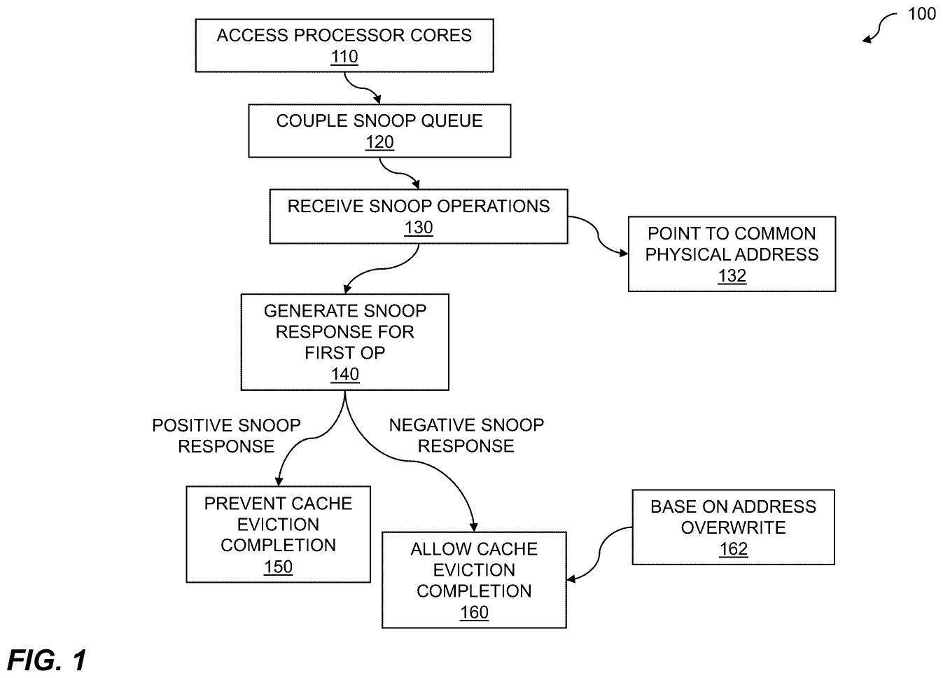

FIG. 1 is a flow diagram for cache snoop replay management. A plurality of processor cores is accessed, in which each processor of the plurality of processor cores includes a local cache that is shared by the other processor cores. Coherency must be maintained across the various cache memories. The maintaining coherency ensures that cache lines contained in the cache memories are synchronized. If a particular cache line in a cache is written by a core, then that cache line in any and every other cache that has a copy of that cache line must be updated. There are inefficiencies and overheads associated with coherency maintenance. To maintain coherency across the local caches, the plurality of processor cores implements, as a cache maintenance operation, a special cache coherency operation which is a global snoop operation. The global snoop operation is initiated by an agent within the globally coherent system that monitors all bus transactions and identifies any transaction that modifies a local cache block. The global snoop operation ensures that any change to a cache block in a local cache is propagated to any other local cache that maintains a copy of that cache block. The special cache coherency operation can include a CLEAN operation that is carried out on a cache block. The clean operation causes overwritten or “dirty” data to be written into a buffer such as an evict buffer as an evict buffer entry. The overwritten data is held for a later write to downstream caches or memory by an eviction operation. The buffer entry can be marked to enable management of cache eviction operation. The evict buffer has the capability to enable delayed writes. An additional write to the evict buffer may or may not be a duplicate of the original evict buffer write. Two or more snoop operations can be received for the shared local cache, where the snoop operations can point to a common cache-line physical address within the shared local cache. The snoop operations are enqueued in a snoop queue. A snoop response is generated for the first snoop operation. The snoop response can prevent or allow a cache eviction operation to complete or not. A cache eviction operation is prevented from completing, based on the snoop response being completed with a positive cache-line physical address comparison. A positive cache-line physical address comparison indicates that the snoop response found a common cache-line physical address match. Alternatively, the cache eviction operation is allowed to complete, based on the snoop response being completed with a negative cache-line physical address comparison. The negative cache-line physical address comparison indicates that the physical addresses associated with the two or more snoop operations did not match. The cache-line physical address comparison can be a partial cache-line physical address comparison.

The flow 100 includes accessing a plurality of processor cores 110. The number of cores could be one or more than one. The more sophisticated and computationally powerful processors can contain eight or more cores. A typical desktop computer will contain between two and eight cores. Video and audio processing activities place higher loads on a CPU and thereby benefit from a greater number of cores than sending email or running only one or two software programs at a time. Each core has requirements for instruction and data storage. Instruction and data traffic can exist on one bus of sufficient bit width or can be on separate bus structures. Each processor of the plurality of processor cores can include a shared local cache. The shared local cache is included because electrically distant main memory such as a spinning hard drive or solid-state drive, or other storage mechanism has a relatively slow access time compared to the instruction cycle speed in the core. For a given architecture, there can be separate instruction and data caches, or instructions and data can be combined within a single cache. Cache storage is local storage that holds data that has been accessed by a core, with the likelihood that the same data will be used again. One or more hierarchical levels of cache storage can be used. In a desktop computer the Level 1 (L1) cache might be 256 KB, and the next hierarchical and more distant Level 2 (L2) cache might be 1 MB. In a similar fashion a Level 3 (L3) cache in this example could be 8MB. L1 and L2 cache memories can reside in the core circuitry in the monolithic chip, with L2 being more distant from the bus. L3 memory is typically somewhere in physical proximity to, but not on, the monolithic chip. Cache memories are very small and finite compared to final storage. As a result, the cache memories eventually will run out of space for most, if not all, applications. The shared local cache supports snoop operations. A snoop operation can be used to determine whether a cache line is accessed by more than one access operation, where an access operation can include a load (read), a store (write), or a read-modify-write operation. The cache line that is snooped can be categorized as modified, exclusive, shared, or invalid (MESI).

The shared local cache can be coupled to a plurality of the processor cores. In embodiments, the shared local cache can be coupled to a grouping of two or more processor cores of the plurality of processor cores. The coupling can be accomplished by colocating the local cache and the grouping of processor cores, using a special interconnect among the cache and the cores, and so on. The coupling can enable sharing. In embodiments, the shared local cache can be shared among the two or more processor cores. Discussed previously and throughout, sharing a cache among multiple processor cores can introduce memory access timing issues. The timing issues can be resolved using various coherency techniques. In embodiments, the grouping of two or more processor cores and the shared local cache can operate using local coherency. The local coherency operation can check for memory access conflicts, resolve dirty data issues, etc. Recall that coherency techniques can also include global coherency techniques, where global coherency can be associated with all processor cores, shared local caches, intermediated caches, share common memory, and so on. In embodiments, the local coherency can be distinct from a global coherency.

Embodiments can include performing a cache maintenance operation in the grouping of two or more processor cores and the shared local cache. The coherency of data can be maintained by the plurality of processor cores performing Cache Maintenance Operations (CMOs). In embodiments, the cache maintenance operation can generate cache coherency transactions between the global coherency and the local coherency. A cache controller, which is a separate hardware block that transparently manages cache operations, reads or writes data between cache memory and main memory. The cache memory may include one or more levels of cache memory. In embodiments the plurality of processor cores can implement special cache coherency operations as part of the collection of CMO(s). The coherency operation is a global snoop operation that is initiated by an agent within the globally coherent system. Snooping is a process accomplished by the cache controller to monitor bus transactions. When one cache block, or cache line, is modified by its core, the cache controller ensures that the cache line is updated in the remainder of the shared cache memories. A cache line holds data, an address, and one or more status bits. Embodiments can further include performing a global snoop operation on the shared local cache (discussed below).

The flow 100 includes coupling a snoop queue 120 to the plurality of processor cores, wherein the snoop queue is shared among the plurality of processor cores. The snoop queue can be used to store snoop operations. The snoop operations can be generated by the cache controller. In the process of managing a cache, a cache line may need to be removed to make space for new data. Several protocols exist for determining what cache lines are eligible for removal, among them Least Recently Used (LRU). The process of removal can be triggered in a number of ways, among them the CLEAN instruction. The removal process is called eviction and must include the propagation of the data in the cache line back to main memory. The data to be evicted can be stored in a buffer such as an evict buffer. The evict buffer is an intervening temporary storage area that allows evicted data to be held for a time. The evict buffer is shared among the plurality of processor cores. The evict buffer enables delayed writes before propagating the data through the hierarchical cache structure to main memory.

The flow 100 includes receiving two or more snoop operations for the shared local cache 130. The snoop operations can be generated as a result of a memory access request, where the memory access request can include a load or store operation. The snoop operations can be generated by one or more processor cores, by the cache controller, and so on. In embodiments, the two or more snoop operations can originate from with a compute coherency block (CCB) or from outside of the CCB. In the flow 100, the two or more snoop operations can point to a common cache-line physical address 132 within the shared local cache. The snoop operations can be based on a substantially similar access operations such as load operations or store operations. The snoop operations can be based on substantially dissimilar operations such as a load operation and a store operation. The access operations that generated the snoop operations may or may not interfere. In a usage example, the memory access operations include load operations. Load operations do not change the contents of the storage by reading the contents. On the other hand, if at least one of the snoop operations is associated with a store operation, then the contents of the storage location or address will change. Thus, a memory access hazard can exist. A memory access hazard can include reading or writing data “at the wrong time”. That is, valid data can be overwritten, invalid data can be read, and so on. In embodiments, the two or more snoop operations are enqueued in the snoop queue. The snoop operations can be enqueued in the order in which the operations were received, in a specified order, etc.

The flow 100 includes generating a snoop response 140 to a first snoop operation of the two or more snoop operations. The snoop response can be generated by a processor core, by the cache controller, and so on. The snoop response can include a positive snoop response or a negative snoop response (discussed below). The snoop response can be based on a comparison of addresses. The comparison of addresses can include comparing a cache-line aligned physical address of an evicted cache line with cache-line aligned physical addresses of all outstanding snoop operations. The comparison can be based on the full physical address (e.g., a full compare), a portion of the physical address (e.g., a partial compare), and so on. A partial address comparison can be faster than a full address comparison. In embodiments, the partial cache-line physical address comparison can be performed between a cache-line aligned physical address of a cache eviction operation and all cache-line aligned physical addresses of outstanding snoop entries in the snoop queue. The comparison can determine whether one or more of the outstanding snoop operations will, when executed, access the same physical address as the cache line designated for eviction. A directory can be used to keep track of which cache lines are to be evicted and which cache lines will be accessed by the outstanding snoop operations. In embodiments, a directory can include a snoop bit for each of the snoop entries. The snoop bit can be set or reset. In embodiments, the snoop bit can be set based on a pending cache-line snoop operation in the snoop queue. The snoop bit can be set because a pending cache-line snoop operation can access the same physical address. In other embodiments, the snoop bit can be cleared based on a last snoop replay for a pending cache-line snoop operation in the snoop queue.

Continuing the discussion of the partial cache-line physical address comparison, in embodiments, the partial cache-line physical address comparison can be based on a cache-line physical address couplet. The couplet can include address bits such as a quantity of most significant address bits (MSBs), one or more fields, and so on. In embodiments, the cache-line physical address couplet can include a set-index field concatenated to a set-way field. The set-index field can indicate which set of a plurality of sets within a cache is associated with the cache-line physical address. Note that a local cache can include a set-associative cache, where the cache can include a quantity of equally sized blocks or “ways”. The set-way field can indicate which way or block within the local cache contains the cache line associated with the cache-line physical address. Embodiments can further include comparing the cache-line physical address couplet to a snoop request physical address couplet. The physical address couplet can include a quantity of address bits, fields, etc. In embodiments, the comparing the cache-line physical address couplet to a snoop request physical address couplet can occur prior to the preventing. The result of the comparing, if positive, can prevent the cache eviction operation from completing, or, if negative, can allow the cache eviction operation to complete. In other embodiments, the cache-line physical address couplet can include a constant value for a cache line that is being snooped.

Noted previously, a snoop operation response can include a positive response or a negative response. A positive snoop operation response can indicate a positive cache-line physical address comparison, while a negative snoop operation response can indicate a negative positive cache-line physical address comparison. The flow 100 includes preventing a cache eviction operation from completing 150. The preventing the cache eviction operation from completing is based on the snoop response being completed with a positive cache-line physical address comparison. The cache-line physical address comparison comprises a partial cache-line physical address comparison. The positive snoop operation response can indicate that one or more pending snoop operations also access the physical address of a cache line. Recall that evicting a cache line can be due to a cache line to be accessed not being in the local cache. The evicting a cache line can also be due to a coherency management operation, where the CMO is issued to maintain local coherency among processor cores and a shared local cache. The CMO can also maintain coherency among the shared local cache and other shared local caches; an intermediate cache; a shared common memory; etc.

The flow 100 further includes allowing the cache eviction operation to complete 160, based on the snoop response being completed with a negative cache-line physical address comparison. The negative snoop response can indicate that none of the outstanding snoop requests access the substantially similar cache-line physical address as the cache-line physical address associated with the eviction operation. That is, since the contents of the cache-line physical address will not be accessed or potentially changed by any of the outstanding snoop operations, the cache line can be safely evicted. Note that while responses to all outstanding snoop operations within the snoop queue can be generated, one or more snoop requests could be “in flight” from a processor core within a local compute coherency block, from a global coherency operation, and so on. In embodiments, the negative cache-line physical address comparison can indicate an absence of in-flight snoop requests for the cache-line physical address.

The flow 100 further includes allowing the cache eviction operation to complete 162, based on the common cache-line physical address being overwritten in the shared local cache. The common cache-line physical address being overwritten can result from overwriting by one or more processor cores associated with the grouping of processor cores storing data into the physical address of the local cache. The overwriting can occur with a local compute coherency block. The overwriting can also result from a global coherency management operation. In embodiments, the overwriting can be performed by an evict fill operation. An evict fill operation can include loading a cache line, a cache line block, etc., into the local cache. In other embodiments, the evict fill operation can clear a valid bit in a directory. The clearing the valid bit in the directory can be used to indicate that the cache line in the local cache has been changed.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

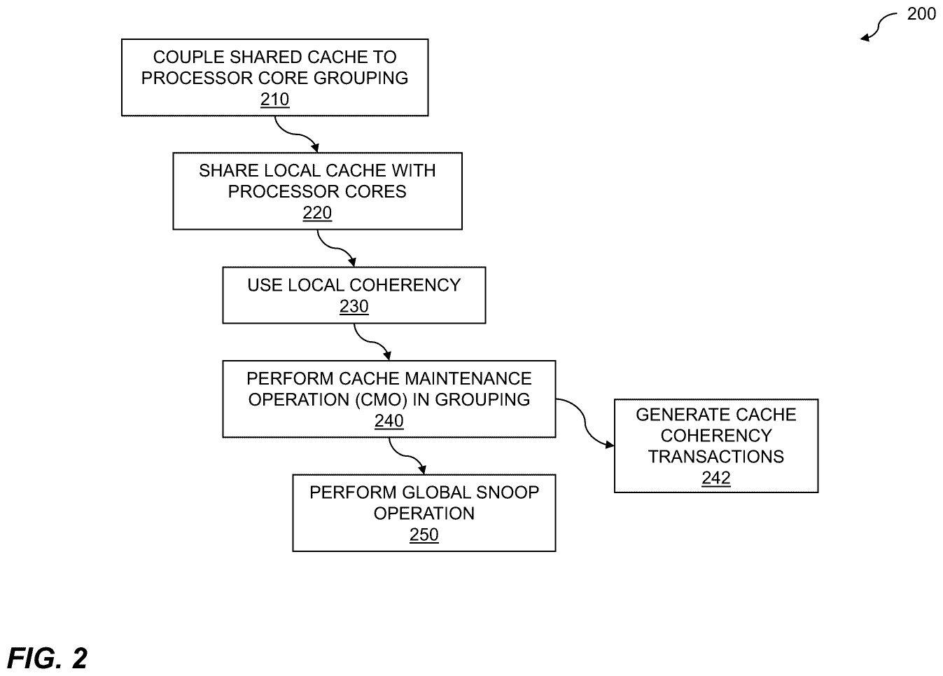

FIG. 2 is a flow diagram for shared local cache usage. Discussed previously and throughout, a plurality of processor cores accesses a shared local cache. The shared local cache can hold data, instructions, operations, and so on. In embodiments, the shared local cache can be used to hold data comprising cache-lines. The cache-lines can be loaded from a memory such as a shared common memory. The shared common memory can store data that can be processed by one or more of the processor cores. One or more of the processor cores that can access a shared local cache can modify the contents of the local cache. This modified or dirty data can be moved to an evict queue prior to storing the modified data back out to the shared common memory. Data can be moved or “evicted” from the evict queue, where the evicting includes writing the dirty data back to the shared common memory. The evicting of the data can be delayed or prevented based on one or more snoop operations. The evicting can be prevented in the case that snoop operations that may access a given cache line in the evict queue have yet to be completed.

The shared local cache usage enables cache snoop replay management. A plurality of processor cores is accessed, wherein each processor of the plurality of processor cores includes a shared local cache, and wherein the shared local cache supports snoop operations. A snoop queue is coupled to the plurality of processor cores, wherein the snoop queue is shared among the plurality of processor cores. Two or more snoop operations are received for the shared local cache, wherein the two or more snoop operations point to a common cache-line physical address within the shared local cache, and wherein the two or more snoop operations are enqueued in the snoop queue. A snoop response is generated to a first snoop operation of the two or more snoop operations. A cache eviction operation is prevented from completing, based on the snoop response being completed with a positive cache-line physical address comparison, wherein the cache-line physical address comparison comprises a partial cache-line physical address comparison.

The flow 200 includes coupling a shared local cache 210 to a processor core grouping. The processor core grouping can include two or more processor cores, where the processor cores can be associated with a processor. The processor can include a multiprocessor such as a RISC-V™ processor. The local cache can include a small, fast local memory colocated with the processor cores, tightly coupled to the processor cores, and so on. The local cache can enable substantial memory access performance improvements compared to accessing a shared common memory. In a usage example, data such as cache lines located within the local cache can be accessed without the access overhead associated with the shared common memory. The access overhead associated with the shared common memory can include access delays associated with transferring data across a shared bus or network such as a network-on-chip (NOC), transit times associated with a crossbar switch, buffer delays, etc. The local cache can include a single-level cache, a multilevel cache, and so on. The flow 200 includes sharing the local cache 220 with the processor core group. The processor core group can include two or more processor cores where the processor core group can include homogeneous processor cores or heterogeneous processor cores. The processor core group can comprise processor cores associated with one or more processors. The cache can include a multiport cache, a multilevel cache, etc.

The flow 200 includes using local coherency 230. In embodiments, the grouping of two or more processor cores and the shared local cache can operate using local coherency. The local coherency can indicate to processors associated with a grouping of processors that the contents of the cache have been changed or made “dirty” by one or more processors within the grouping. In embodiments, the local coherency is distinct from a global coherency. That is, the coherency maintained for the local cache can be distinct from coherency between the local cache and the common memory, coherency between the local cache and one or more further local caches, etc. The flow 200 includes performing a cache maintenance operation 240 in the grouping of two or more processor cores and the shared local cache. The cache maintenance operations (described below) can include performing a cache maintenance operation (CMO) within the grouping of processor cores. The cache maintenance operation can maintain local coherency of the local cache, coherency between the local cache and the common memory, coherency among local caches, and so on. The flow 200 includes generating cache coherency transactions 242. The cache coherency transactions can include one or more cache maintenance operations. The cache maintenance operations can be based on issuing one or more cache transactions. In embodiments, the cache maintenance operations can include a cache line zeroing operation, a cache line cleaning operation, a cache line flushing operation, and a cache line invalidating operation. The cache transactions can be based on one or more snoop operations. The snoop operations can include one or more global snoop operations.

The flow 200 further includes performing a global snoop operation 250. The global snoop operation can be associated with coherency among the shared common memory, an intermediate cache, one or more shared caches, one or more local caches, and so on. In embodiments, the local coherency is distinct from a global coherency. The global snoop operation can look beyond the compute coherency block associated with the processor core grouping and the shared local cache. The global snoop operation can check for common physical addresses such as cache-line physical addresses. The global snoop operation can check for common cache-line physical addresses among the processors of the one or more processor core groupings; a plurality of shared caches, where each shared cache is shared with a processor core grouping; among caches such as L2 caches, one or more intermediate caches, etc.; the shared common memory; and so on.

Cache maintenance operations can include cache block operations. A cache block can include a portion or block of common memory contents, where the block can be moved from the common memory into a local cache such as the shared local cache. In embodiments, the cache block operations can include a cache line zeroing operation, a cache line cleaning operation, a cache line flushing operation, and a cache line invalidating operation. These operations are discussed in detail below. The cache block operations can be used to maintain coherency. In embodiments, the cache line zeroing operation can include uniquely allocating a cache line at a given physical address with zero value. The zero value can be used to overwrite and thereby clear previous data. The zero value can indicate a reset value. The cache line can be set to a nonzero value if appropriate. In embodiments, the cache line cleaning operation can include making all copies of a cache line at a given physical address consistent with that of memory. Recall that the processors can be arranged in groupings of two or more processors and that each grouping can be coupled to a local cache. One or more of the local caches can contain a copy of the cache line. The line cleaning operation can set or make all copies of the cache line consistent with the common memory contents. In other embodiments, the cache line flushing operation can include flushing any dirty data for a cache line at a given physical address to memory, and then invalidating any and all copies. The “dirty” data can result from processing a local copy of data within a local cache. The data within the local cache can be written to the common memory to update the contents of the physical address in the common memory. In further embodiments, the cache line invalidating operation can include invalidating any and all copies of a cache line at a given physical address without flushing dirty data. Having flushed data from a local cache to update the data at a corresponding location or physical address in the common memory, all remaining copies of the old data within other local caches become invalid.

The cache line instructions just described can be mapped to standard operations or transactions for cache maintenance, where the standard transactions can be associated with a given processor type. In embodiments, the processor type can include a RISC-V™ processor core. The standard cache maintenance transactions can differ when transactions occur from the cores and when transactions occur to the cores. The transactions can comprise a subset of cache maintenance operations, transactions, and so on. The subset of operations can be referred to as cache block operations (CBOs). The cache block operations can be mapped to standard transactions associated with an ARM™ Advanced extensible Interface (AXI™) Coherence Extensions (ACE™) interface, an Advanced Microcontroller Bus Architecture (AMBA™) Coherence Hub Interface (CHI™), etc. In embodiments, the cache coherency transactions can be issued globally before being issued locally. A globally issued transaction can include a transaction that enables cache coherency from a core to cores globally. The issuing cache coherency transactions globally can prevent invalid data from being processed by processor cores using local, outdated copies of the data. The issuing cache coherency transactions locally can maintain coherency within compute coherency blocks (CCBs), each managing a grouping of processors. In embodiments, the cache coherency transactions that are issued globally can complete before cache coherency transactions are issued locally. A variety of indicators, such as a flag, a semaphore, a message, a code, and the like, can be used to signify completion. In embodiments, an indication of completeness can include a response from the coherent network-on-chip.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

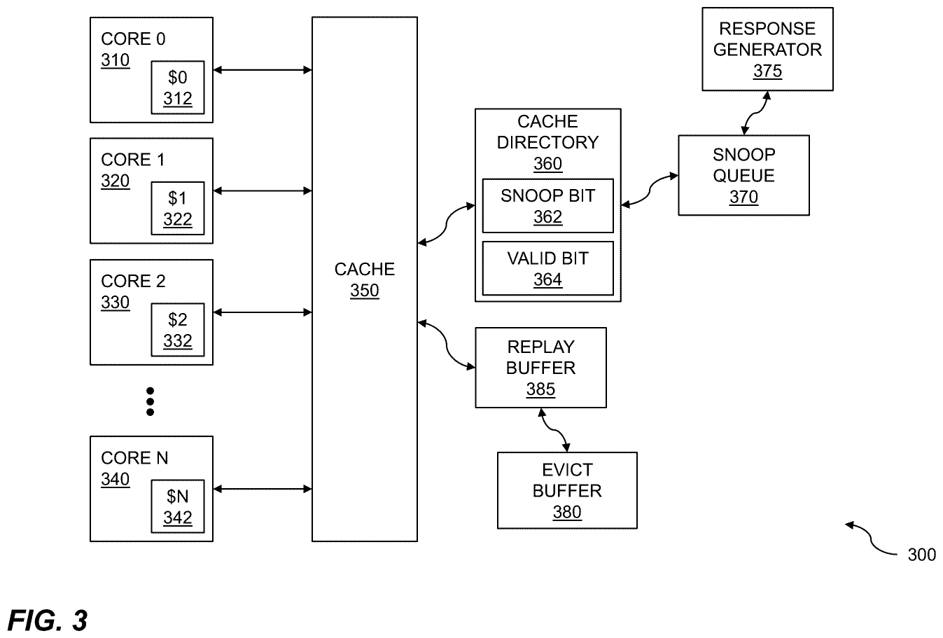

FIG. 3 is a system block diagram showing snoop replay management. A storage element such as cache storage can hold information. The information that is held can include instructions or operations, data, processing results, parameters, coefficients, and so on. The cache storage can include a local cache associated with a core such as a processor core, a cache shared between or among processor cores, a cache accessible to a plurality of processor cores, an intermediate cache, and so on. Accessing instructions and data within the local cache is typically significantly faster than accessing the instructions and the data within a shared memory such as a shared memory system. The access is faster because the cache is smaller than the memory system and is located in close proximity to at least one processor core. The closer proximity of the cache can provide instructions and data without the additional access delays associated with a shared bus or communications network, a crossbar switch, buffers, slower access times of a large memory system, etc. However, coherency must be maintained among data in the local and other local caches, shared caches, the memory system, and so on. Maintaining coherency can include managing orders in which read operations and write operations are executed so that needed data is not overwritten before it can be read, data is written after the data is read, and the like.

Cache management is enabled by cache snoop replay management. A plurality of processor cores is accessed, wherein each processor of the plurality of processor cores includes a shared local cache, and wherein the shared local cache supports snoop operations. A snoop queue is coupled to the plurality of processor cores, wherein the snoop queue is shared among the plurality of processor cores. Two or more snoop operations are received for the shared local cache, wherein the two or more snoop operations point to a common cache-line physical address within the shared local cache, and wherein the two or more snoop operations are enqueued in the snoop queue. A snoop response is generated to a first snoop operation of the two or more snoop operations. A cache eviction operation is prevented from completing, based on the snoop response being completed with a positive cache-line physical address comparison, wherein the cache-line physical address comparison comprises a partial cache-line physical address comparison.

The system block diagram 300 includes a plurality of processor cores such as processor core 0 310, core 1 320, core 2 330, and core N 340. While four processor cores are shown, other numbers of cores can be included, as implied by core N. The processor cores can include multicore processors such as a RISC-V™ processor. The processor cores can generate read operations, which can access a common memory structure coupled to the processor cores. The read operations can be generated by any number of other processor cores located within a compute coherency domain (CCD). Each processor core can include a local cache. The local caches can include cache $0 312 associated with core 0 310; cache $1 322 associated with core 1 320; cache $2 332 associated with core 2 330; and cache $N 342 associated with core N 340. The local caches can hold one or more cache lines that can be operated on by the core associated with a local cache. The system block diagram 300 can include a cache 350. The cache can include a hierarchical cache. The hierarchical cache can be shared among the processors within the plurality of processor cores. The hierarchical cache can include a single level cache or a multilevel cache. The hierarchical cache can comprise a level two (L2) cache, a level three (L3) cache, a unified cache, and so on. The hierarchical cache can comprise a last level cache (LLC) for a processor core grouping.

Embodiments can include a coherent cache structure (not shown). The coherent cache structure can enable coherency maintenance between the one or more local caches such as local caches 312, 322, 332, and 342 associated with the processor cores 310, 320, 330, and 340, respectively, and the cache 350. The coherent cache structure can be managed using a cache line directory along with other compute coherency block logic and storage functionality. In embodiments, the coherency block can include a snoop generator (not shown). Snoop operations can be used to detect storage access operations that can change data at a storage address of interest. A storage address of interest can include a storage address associated with operations such as load and/or store operations. Recall that two or more processor cores can access the common memory, one or more local caches, memory queues, and so on. Access by a memory core to an address associated with any of the storage elements can change the data at that address. The snoop operations can be used to determine whether an access operation to a storage address could cause a cache coherency problem or “hazard”, such as overwriting data waiting to be read, reading old or stale data, and so on. In embodiments, the snoop operations can be based on physical addresses for the common memory structure. The physical addresses can include absolute, relative, offset, etc. addresses in the common memory structure. The physical addresses can include cache-line physical addresses.

The system block diagram 300 can include a cache directory 360. The cache directory can be based on a coherent cache structure or other representation and can be used to manage coherency of a compute coherency block (CCB), a plurality of CCBs, and so on. The coherent cache structure can be further managed using other compute coherency block logic and storage functionality. In embodiments, the coherency block can include a snoop generator. Snoop operations can be used to detect storage access operations that can change data at a storage address of interest. A storage address of interest can include a storage address associated with operations such as load and/or store operations. Recall that two or more processor cores can access the common memory, one or more local caches, memory queues, and so on. Access by a memory core to an address associated with any of the storage elements can change the data at that address. The snoop operations can be used to determine whether an access operation to a storage address could cause a cache coherency problem, such as overwriting data waiting to be read, reading old or stale data, and so on. In embodiments, the snoop operations can be based on physical addresses for the common memory structure. The physical addresses can include absolute, relative, offset, etc. addresses in the common memory structure.

The cache directory can include a snoop bit 362. A snoop bit can be associated with each physical cache-line address within the cache directory. In embodiments, a snoop bit, from the directory, for an addressed cache-line, can determine whether there is a snoop outstanding for the cache line. The snoop bit can be cleared by the last snoop response for the cache line. Note that while a snoop response such as a last snoop response may be received, a read response sent to a core that generated a snoop request may remain outstanding. A subsequent snoop issued to the same physical address may possibly be sent before the read response is received, thereby causing a coherency failure. To counter this potential coherency issue, the physical address of the cache line can be compared to physical address requested by an “in-flight” snoop that can be replayed in the snoop queue. Instead of comparing the full physical address of each cache-line associated with the cache directory, a reduced comparison can be performed. The reduced comparison can be based on a couplet, where the couplet comprises a set index and a set way. The couplet comprises fewer bits than an address such as a cache-line aligned physical address. The couplet can remain constant for a cache line that is being snooped since the cache-line cannot be evicted (e.g., sent to update shared system memory) until all outstanding snoop operations are completed. The cache directory can further include a valid bit 364. The valid bit can indicate whether a cache line is valid. The valid bit can be set and reset based on whether a cache line has been written. In a usage example, a cache-line fill, such as an evict fill (discussed below) can overwrite a line in the cache. As a result of the write, the couplet is no longer valid. Thus, the fill write can clear the valid bit of the couplet thereby indicating that the cache line has been changed by the fill.

The system block diagram 300 can include a snoop queue 370. The snoop queue can hold one or more snoop operations. The snoop queue can be shared among the plurality of processor queues. The snoop operations can point to a common cache-line physical address such as a physical address within a shared local cache. The contents of the snoop queue can be used for a cache-line physical address comparison, where the comparison can include a partial address comparison. In embodiments the partial cache-line physical address comparison can be performed between a cache-line aligned physical address of the cache eviction operation and all cache-line aligned physical addresses of outstanding snoop entries in the snoop queue. As stated above, in embodiments, a directory such as the cache directory can include a snoop bit for each of the snoop entries. The snoop bit can be set or cleared. In embodiments, the snoop bit can be set based on a pending cache-line snoop operation in the snoop queue. More than one cache-line snoop operation can be pending. In other embodiments, the snoop bit can be cleared based on a last snoop replay for a pending cache-line snoop operation in the snoop queue.

The system block diagram 300 can include a response generator 375. The snoop generator can generate a snoop response to a snoop operation enqueued in the snoop queue. A snoop response can include a positive response or a negative response. A positive snoop response can include a positive cache-line physical address comparison, and a negative snoop response can include a negative cache-line physical address comparison. The physical address comparison can include a partial cache-line physical address comparison, as discussed previously. Embodiments can include allowing a cache eviction operation to complete, based on the snoop response being completed with a negative cache-line physical address comparison. The negative comparison can indicate that no snoop operations remain in the queue. Further, in embodiments, the negative cache-line physical address comparison can indicate an absence of in-flight snoop requests for the cache-line physical address.

The system block diagram 300 can include an evict buffer 380. The evict buffer is coupled to the plurality of processor cores and is shared among the plurality of processor cores. The evict buffer can store “dirty” data, where the dirty data includes data that has been changed in a cache such as a local cache, hierarchical cache, etc. The dirty data is the result of a change to a local copy of data loaded from shared storage. In order to maintain coherency of data, data that is changed in, for example, a local cache, must be written out to or stored in the shared storage. Further, other local copies of the data must reflect changes to the data. However, changes to other local copies of the data must be properly ordered to avoid loading of stale data, storing of data that is required by another process, and so on. The orchestrating of the writes to the evict buffer can be monitored to identify a special cache coherency operation. In embodiments, the special cache coherency operation that was identified can include a global snoop operation. The global snoop operation can look for memory access operations such as load operations and store operations. The monitoring of store operations can monitor for writing to a substantially similar storage location. In embodiments, the partial address can include a cache set index. When a fast compare indicates that a write duplication match can be present, then the additional evict buffer write can be stored in an additional buffer.

The system block diagram can include a replay buffer 385. The replay buffer can be used to store additional evict buffer writes. Additional evict buffer writes are compared with evict buffer writes already in the evict queue. The comparing can determine whether the additional evict buffer write is attempting to write to a storage location to which a previous a previous evict buffer write is also attempting to write. Embodiments can further include performing a fast compare between the additional evict buffer write and the evict buffer entry that was marked to detect duplication. A fast compare can be based on comparing a portion of address bits associated with the additional evict buffer write with address bits associated with evict buffer writes previously loaded into the evict buffer. The fast compare can indicate whether an address may be referenced by another evict buffer write. Embodiments can include sending the additional evict buffer write to a replay buffer, based on a duplication match in the fast compare. Since the fast compare can indicate that duplicate evict buffer writes (e.g., writes to the same storage location) may exist, a detailed search can be conducted to determine whether there is an exact match. Embodiments can include performing a full compare between the additional evict buffer write that was sent to the replay buffer with the evict buffer entry that was marked. The fast compare and the full compare can be accomplished using logic. In embodiments, logic for the fast compare and the full compare can include shared logic.

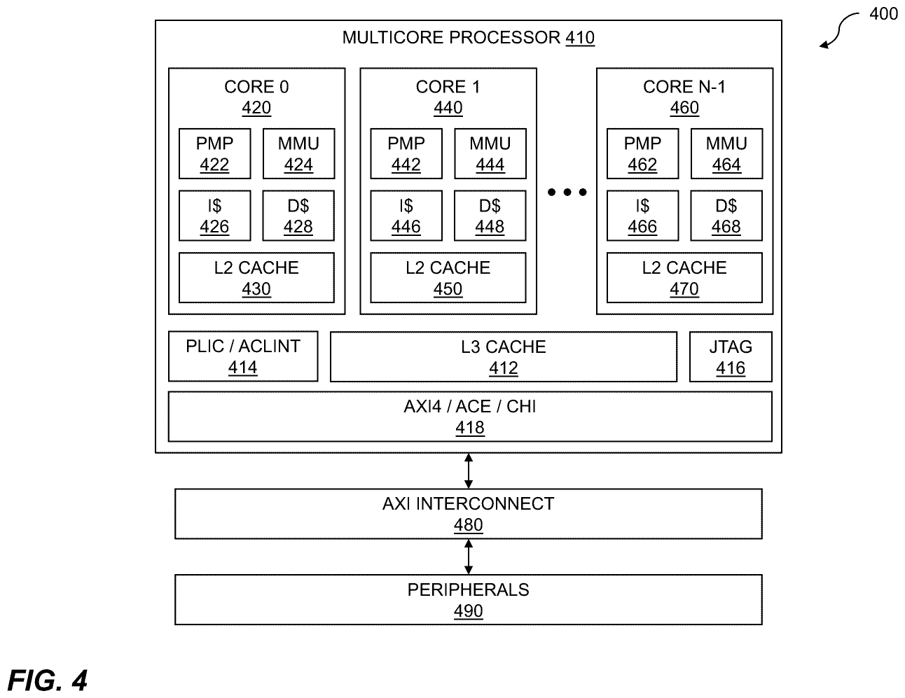

FIG. 4 is a block diagram illustrating a RISC-V™ processor. A processor, such as a RISC-V™ processor, can comprise two or more processor cores, where the processor cores can include homogeneous processor cores or heterogeneous processor cores. The processor can include a variety of elements. The elements can include a plurality of processor cores, one or more caches, memory protection and management units, local storage, and so on. The elements of the multicore processor can further include one or more of a private cache, a shared local cache, a test interface such as a Joint Test Action Group (JTAG) test interface, one or more interfaces to a network such as a network-on-chip (NoC), a coupling to a common memory structure, peripherals, and the like. The multicore processor is supported by cache snoop replay management. A plurality of processor cores is accessed, wherein each processor of the plurality of processor cores includes a shared local cache, and wherein the shared local cache supports snoop operations. A snoop queue is coupled to the plurality of processor cores, wherein the snoop queue is shared among the plurality of processor cores. Two or more snoop operations are received for the shared local cache, wherein the two or more snoop operations point to a common cache-line physical address within the shared local cache, and wherein the two or more snoop operations are enqueued in the snoop queue. A snoop response is generated to a first snoop operation of the two or more snoop operations. A cache eviction operation is prevented from completing, based on the snoop response being completed with a positive cache-line physical address comparison, wherein the cache-line physical address comparison comprises a partial cache-line physical address comparison.

The block diagram 400 can include a multicore processor 410. The multicore processor can comprise two or more processors, where the two or more processors can include homogeneous processors, heterogeneous processors, etc. In the block diagram, the multicore processor can include N processor cores such as core 0 420, core 1 440, core N-1 460, and so on. Each processor can comprise one or more elements. In embodiments, each core, including cores 0 through core N-1, can include a physical memory protection (PMP) element, such as PMP 422 for core 0; PMP 442 for core 1, and PMP 462 for core N-1. In a processor architecture such as the RISC-V™ architecture, a PMP can enable processor firmware to specify one or more regions of physical memory such as cache memory of the common memory, and to control permissions to access the regions of physical memory. The cores can include a memory management unit (MMU) such as MMU 424 for core 0, MMU 444 for core 1, and MMU 464 for core N-1. The memory management units can translate virtual addresses used by software running on the cores to physical memory addresses with caches, the common memory system, etc.

The processor cores associated with the multicore processor 410 can include caches such as instruction caches and data caches. The caches, which can comprise level 1 (L1) caches, can include an amount of storage such as 16KB, 32KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N-1. In addition to the level 1 instruction and data caches, each core can include a level 2 (L2) cache. The level 2 caches can include L2 cache 430 associated with core 0; L2 cache 450 associated with core 1; and L2 cache 470 associated with core N-1. Each core associated with multicore processor 410, such as core 0 420, and its associated cache(s), elements, and units can be “coherency managed” by a CCB. Each CCB can communicate with other CCBs that comprise the coherency domain. The cores associated with the multicore processor 410 can include further components or elements. The further elements can include a level 3 (L3) cache 412. The level 3 cache, which can be larger than the level 1 instruction and data caches, and the level 2 caches associated with each core, can be shared among all of the cores. The further elements can be shared among the cores. The further elements can be unique to a given CCB or can be shared among various CCBs. In embodiments, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide a boundary within the cores of the multicore processor. The JTAG can enable fault information to a high precision. The high-precision fault information can be critical to rapid fault detection and repair.

The multicore processor 410 can include one or more interface elements 418. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 400, the interface elements can be coupled to the interconnect. The interconnect can include a bus, a network, and so on. The interconnect can include an AXI™interconnect 480. In embodiments, the network can include network-on-chip functionality. The AXI™interconnect can be used to connect memory-mapped “master” or boss devices to one or more “slave” or worker devices. In the block diagram 400, the AXI interconnect can provide connectivity between the multicore processor 410 and one or more peripherals 490. The one or more peripherals can include storage devices, networking devices, and so on. The peripherals can enable communication using the AXI™interconnect by supporting standards such as AMBA™ version 4, among other standards.

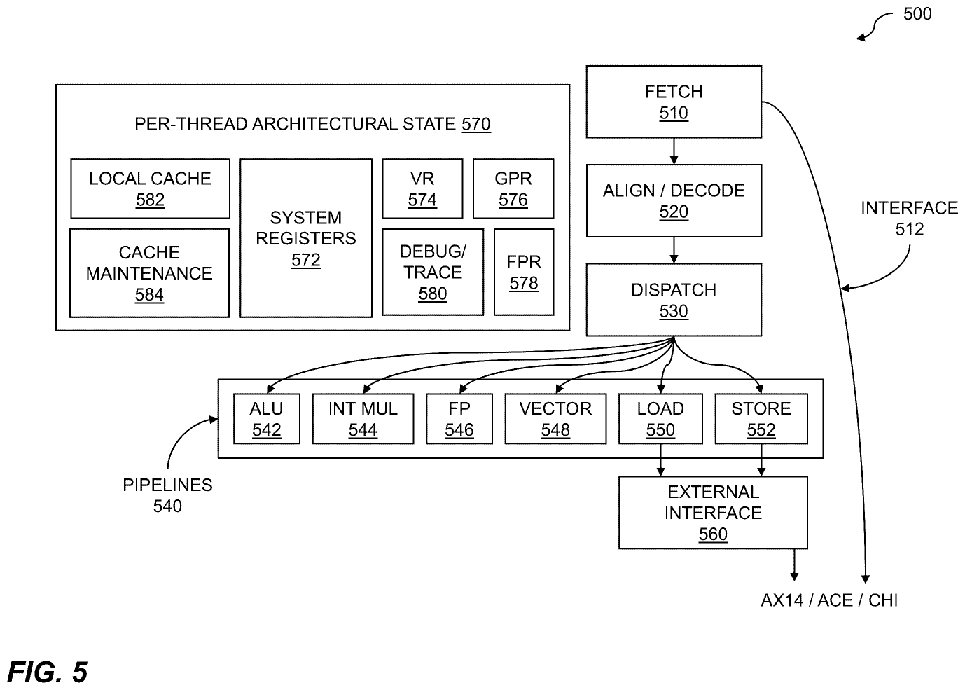

FIG. 5 is a block diagram for a pipeline. Associating and using one or more pipelines with a processor architecture can greatly enhance processing throughput. The processor architecture can comprise one or more processor cores, multiprocessors, storage elements, and so on. The processing throughput can be increased because multiple operations can be executed in parallel. The use of one or more pipelines supports cache snap replay management. A plurality of processor cores is accessed, wherein each processor of the plurality of processor cores includes a shared local cache, and wherein the shared local cache supports snoop operation. A snoop queue is coupled to the plurality of processor cores, wherein the snoop queue is shared among the plurality of processor cores. Two or more snoop operations are received for the shared local cache, wherein the two or more snoop operations point to a common cache-line physical address within the shared local cache, and wherein the two or more snoop operations are enqueued in the snoop queue. A snoop response is generated to a first snoop operation of the two or more snoop operations. A cache eviction operation is prevented from completing, based on the snoop response being completed with a positive cache-line physical address comparison, wherein the cache-line physical address comparison comprises a partial cache-line physical address comparison.

The FIG. 500 shows a block diagram of a pipeline such as a processor core pipeline. The blocks within the block diagram can be configurable in order to provide varying processing levels. The varying processing levels can be based on processing speed, bit lengths, and so on. The block diagram 500 can include a fetch block 510. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The block diagram 500 can include a dispatch block 530. The dispatch block can receive decoded instruction packets from the align and decode block. The decode instruction packets can be used to control a pipeline 540, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipelines that can include load pipelines 550, and store pipelines 552. The load pipelines and the store pipelines can access storage such as the common memory using an external interface 560. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, to trigger one or more exceptions, and so on.

In embodiments, the plurality of processors can be configured to support multi-threading. The system block diagram can include a per-thread architectural state block 570. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 572. The system registers can be associated with individual processors, a system comprising multiple processors, and so on. The system registers can include exception and interrupt components, counters, etc. The per-thread architectural state can include further registers such as vector registers (VR) 574, general purpose registers (GPR) 576, and floating-point registers 578. These registers can be used for vector operations, general purpose (e.g., integer) operations, and floating-point operations, respectively. The per-thread architectural state can include a debug and trace block 580. The debug and trace block can enable debug and trace operations to support code development, troubleshooting, and so on. In embodiments, an external debugger can communicate with a processor through a debugging interface such as a joint test action group (JTAG) interface. The per-thread architectural state can include local cache state 582. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 584. The cache maintenance state can include maintenance needed, maintenance pending, and maintenance complete states, etc.

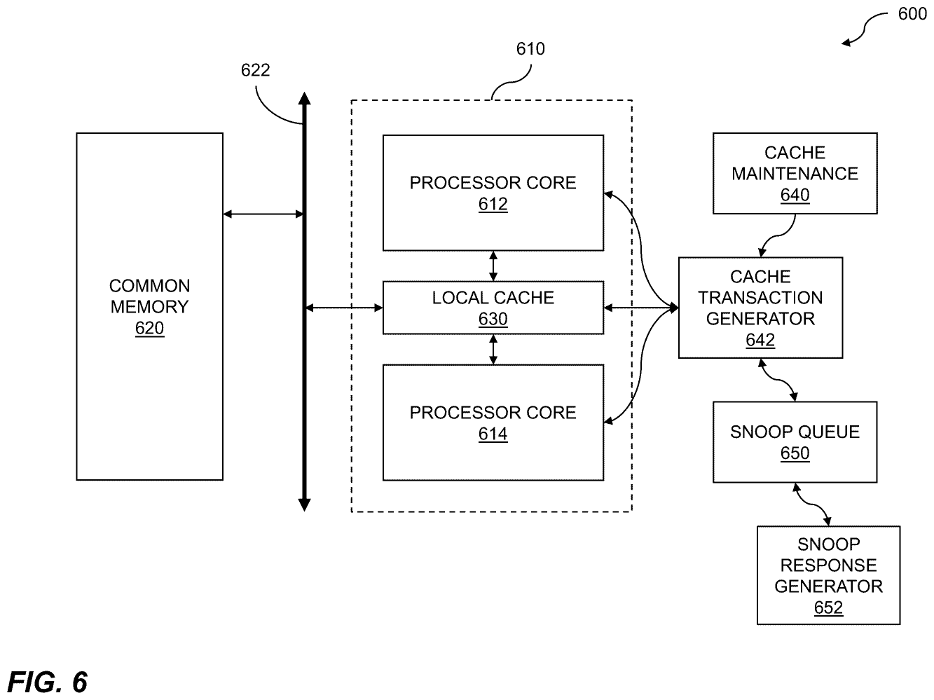

FIG. 6 is a system block diagram illustrating processor cores with cache management. In embodiments, each processor core can be coupled to a local cache. The processor cores and local caches can be arranged into groupings of two or more processor cores. In embodiments, a hierarchical cache can be coupled to the plurality of processor cores, where the plurality of processor cores and the hierarchical cache comprise a compute coherency block (CCB). The hierarchical cache and the local caches can be loaded with data from a source such as a shared, common memory structure. The processor cores coupled to the hierarchical cache can process the data within the cache, causing the data to become “dirty” or different from the contents of the common memory. Since multiple groupings of processor cores can each be coupled to their own local caches, the problem of incoherency between the contents of the common memory structure, the hierarchical cache, and the local caches becomes highly complex. To resolve the coherency challenges, one or more coherency management operations can be applied to the data within the local caches, the hierarchical cache, and the common memory structure. An operation such as a snoop operation can examine common memory and cache access operations so that the access operations can be properly ordered, and cache coherency problems can be avoided. Proper ordering can include ordering access operations such that access race condition are avoided. Access race conditions include read-before-write, read-after-write, and so on. The coherency management operations enable cache snoop replay management. A plurality of processor cores is assessed, wherein each processor of the plurality of processor cores includes a shared local cache, and wherein the shared local cache supports snoop operation. A snoop queue is coupled to the plurality of processor cores, wherein the snoop queue is shared among the plurality of processor cores. Two or more snoop operations are received for the shared local cache, wherein the two or more snoop operations point to a common cache-line physical address within the shared local cache, and wherein the two or more snoop operations are enqueued in the snoop queue. A snoop response is generated to a first snoop operation of the two or more snoop operations. A cache eviction operation is prevented from completing, based on the snoop response being completed with a positive cache-line physical address comparison, wherein the cache-line physical address comparison comprises a partial cache-line physical address comparison.

A system block diagram 600 of processor cores with cache management is shown. A multicore processor 610 can include a plurality of processor cores. The processor cores can include homogeneous processor cores, heterogeneous cores, and so on. In the system block diagram 600, two processor cores are shown, processor core 612 and processor core 614. The processor cores can access a common memory 620. The common memory can be accessed by the processor cores via a local cache (discussed below). The common memory can be shared by a plurality of multicore processors. The common memory can be accessed by the plurality of processor cores through a coherent network-on-chip (NoC) 622. The network-on-chip can be colocated with the plurality of processor cores within an integrated circuit or chip, an application-specific integrated circuit (ASIC), a field programmable gate array (FPGA), and so on. The network-on-chip can be used to interconnect the plurality of processor cores and other elements within a system-on-chip (SoC) architecture. The network-on-chip can support coherency between the common memory 620 and one or more local caches (described below) using coherency transactions. In embodiments, the cache coherency transactions can enable coherency among the plurality of processor cores, one or more local caches, and the memory. The cache coherency can be accomplished based on coherency messages, cache misses, and the like.

The system block diagram 600 can include a local cache 630. The local cache can be coupled to a grouping of one or more processor cores within a plurality of processor cores. The local cache can be coupled to the common memory 620 via the NoC 622. The local cache can include a multilevel cache. In embodiments, the local cache can be shared among the two or more processor cores. The cache can include a multiport cache. In embodiments, the grouping of two or more processor cores and the shared local cache can operate using local coherency. The local coherency can indicate to processors associated with a grouping of processors that the contents of the cache have been changed or made “dirty” by one or more processors within the grouping. In embodiments, the local coherency is distinct from the global coherency. That is, the coherency maintained for the local cache can be distinct from coherency between the local cache and the common memory, coherency between the local cache and one or more further local caches, etc.

The system block diagram 600 can include a cache maintenance element 640. The cache maintenance element can maintain coherency of the local cache, coherency between the local cache and the common memory, coherency among local caches, and so on. The cache maintenance can be based on issuing cache transactions. In the system block diagram 600, the cache transaction can be provided by a cache transaction generator 642. In embodiments, the cache coherency transactions can enable coherency among the plurality of processor cores, one or more local caches, and the memory. The contents of the caches can become “dirty” by being changed. The cache contents changes can be accomplished by one or more processors processing data within the caches, by changes made to the contents of the common memory, and so on. In embodiments, the cache coherency transactions can be issued globally before being issued locally. Issuing the cache coherency transactions globally can ensure that the contents of the local caches are coherent with respect to the common memory. Issuing the cache coherency transactions locally can ensure coherency with respect to the plurality of processors within a given grouping. In embodiments, the cache coherency transactions that are issued globally can complete before cache coherency transactions are issued locally. The completion of the coherency transaction issued globally can include a response from the coherent network-on-chip.

The system block diagram 600 can include a snoop queue 650. The snoop queue can be shared among the plurality of processor cores such as processor cores 612 and 614. The snoop queue can receive and hold snoop operations, where two or more snoop operations can point to a common cache-line physical address within the shared local cache. The snoop operations can be based on memory access operations such as a memory load operation or a memory store operation. The snoop operation can be used to check whether other memory access operations can access the common cache-line physical address. In embodiments, the two or more snoop operations can be enqueued in the snoop queue. The snoop operations can be associated with cache coherency operations. Recall that a cache line can become “dirty” by being modified by a processor such as a processor core. The cache line that has become dirty is associated with a local copy of data from memory such as a shared memory. In order to maintain coherency such as coherency of a compute coherency block (CCB), the dirty data must be written out to the shared storage, and all other local copies of the data must be updated. Before the dirty data can be written, a special cache coherency operation must be executed. The special cache coherency operation can include a global snoop operation. The global snoop operation can compare a write operation target address so that the write operations can be performed in an order to prevent data race conditions.

The system block diagram 600 can include a snoop response generator 652. The snoop response generator can generate a positive response or a negative response. In embodiments, a snoop response can be completed with a positive cache-line physical address comparison. The positive cache-line physical address comparison can indicate that two or more snoop operations target substantially similar cache-line physical address in shared storage such as a shared local cache. In other embodiments, the response can be based on the snoop response being completed with a negative cache-line physical address comparison. The negative cache-line physical address comparison can indicate that two or more snoop operations target substantially dissimilar cache-line physical address in the shared storage.

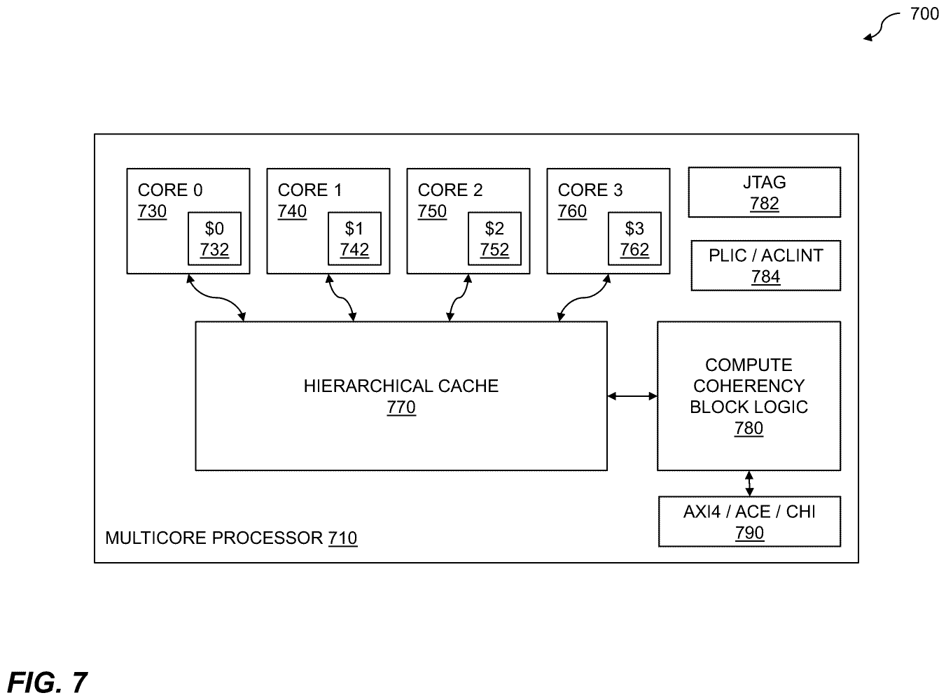

FIG. 7 is a system block diagram showing a compute coherency block (CCB). A compute coherency block can maintain coherency between processors that share a cache memory, between sets of processors that share cache memories, and a shared cache, among processor/cache sets, a shared system cache, and system memory, and so on. That is, the compute coherency block can be used to maintain storage coherency throughout a system, from a cache associated with a processor core up through the system memory. The compute coherency is enabled by checking and controlling write operations from one or more processors into storage. The checking and controlling write operations are enabled by cache snoop replay management. A plurality of processor cores is assessed, wherein each processor of the plurality of processor cores includes a shared local cache, and wherein the shared local cache supports snoop operation. A snoop queue is coupled to the plurality of processor cores, wherein the snoop queue is shared among the plurality of processor cores. Two or more snoop operations are received for the shared local cache, wherein the two or more snoop operations point to a common cache-line physical address within the shared local cache, and wherein the two or more snoop operations are enqueued in the snoop queue. A snoop response is generated to a first snoop operation of the two or more snoop operations. A cache eviction operation is prevented from completing, based on the snoop response being completed with a positive cache-line physical address comparison, wherein the cache-line physical address comparison comprises a partial cache-line physical address comparison.

The system block diagram 700 shows a multicore processor 710. The multicore processor includes compute coherency block (CCB) logic 780. The compute coherency block logic controls coherency among caches coupled to cores, a hierarchical cache, system memory, and so on. Multicore processor 710 includes core 0 730, core 1 740, core 2 750, and core 3 760. While four cores are shown in system block diagram 700, in practice, there can be more or fewer cores. As an example, disclosed embodiments can include 16, 32, or 64 cores. Each core comprises an onboard local cache, which is referred to as a level 1 (L1) cache. Core 0 730 includes local cache 732, core 1 740 includes local cache 742, core 2 750 includes local cache 752, and core 3 760 includes local cache 762.

The multicore processor 710 can further include a joint test action group (JTAG) element 782. The JTAG element 782 can be used to support diagnostics and debugging of programs and/or applications executing on the multicore processor 710. The diagnostics and debugging are enabled by providing access to the processor's internal registers, memory, and other resources. In embodiments, the JTAG element 782 enables functionality for step-by-step execution, setting breakpoints, examining the processor's state during program execution, and/or other relevant functions. The multicore processor 710 can further include a platform level interrupt controller (PLIC), and/or advanced core local interrupter (ACLINT) element 784. The PLIC/ACLINT supports features including, but not limited to, interrupt processing and timer functionalities. The multicore processor 710 can further include a hierarchical cache 770. The hierarchical cache 770 can be a level 2 (L2) cache that is shared among multiple cores within the multicore processor 710. In one or more embodiments, the hierarchical cache 770 is a last level cache (LLC). The multicore processor 710 can further include one or more interface elements 790, which can include standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), as previously described.

Multicore processor 710 further includes compute coherency block (CCB) logic 780. In one or more embodiments, the compute coherency block (CCB) logic is responsible for maintaining coherency between one or more caches such as local caches associated with the processor cores, the hierarchical cache, a shared memory system, and so on. In embodiments, the CCB logic interfaces to the hierarchical cache, and the interface elements. The CCB logic interfaces to the system memory through the interface elements. The compute coherency block logic can perform one or more cache maintenance operations. In embodiments, the CMO can include a cache block operation (CBO) CLEAN instruction. The CCB logic can perform one or more CMO operations in order to resolve data inconsistencies due to “dirty” data in one or more caches. The dirty data can result from changes to the local copies of shared memory contents in the local caches, copies of shared memory contents in the hierarchical cache, etc. The changes to the local copies of data or the hierarchical cache copies of the data can result from processing operations performed by the processor cores as the cores execute code. Similarly, data in the shared memory can be different from the data in a local cache due to an operation such as a write operation.

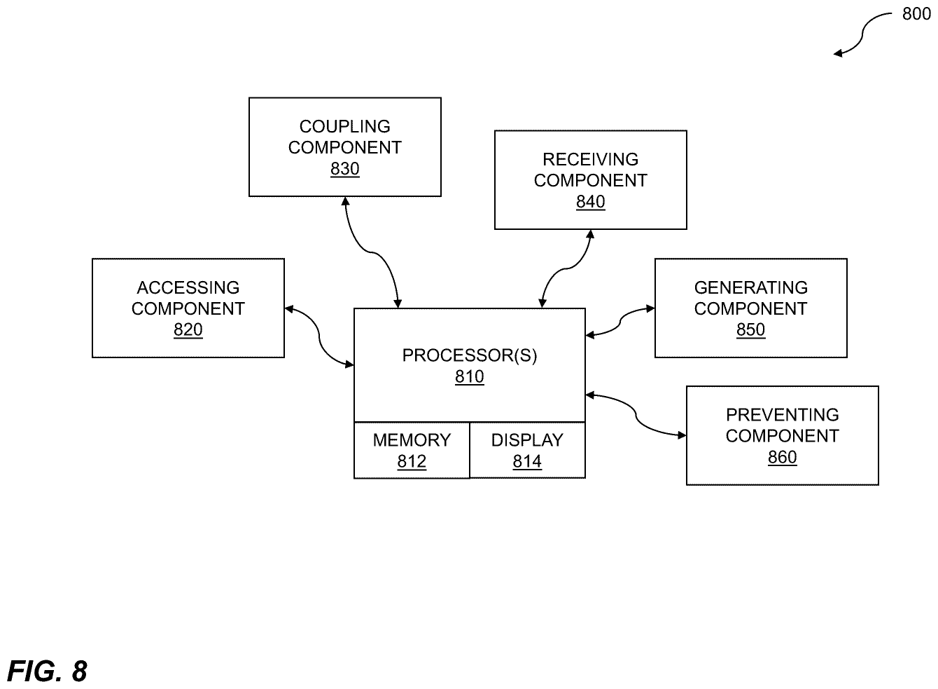

FIG. 8 is a system diagram for cache snoop replay management. The system can comprise a computer system for cache management. The computer system can be based on semiconductor logic. The system can include one or more of processors, memories, cache memories, shared local cache memories, queues, displays, and so on. The system 800 can include one or more processors 810. The processors can include standalone processors within one or more integrated circuits or chips, processor cores in FPGAs or ASICs, two or more processor cores within a multiprocessor, and so on. The one or more processors 810 are coupled to a memory 812, which stores instructions, operations, etc. The memory can include one or more of local memory, shared local cache memory, cache memory, hierarchical cache memory, system memory such as shared system memory, etc. The system 800 can further include a display 814 coupled to the one or more processors 810. The display 814 can be used for displaying data, instructions, operations, memory queue contents, snoop operations, snoop responses, and the like. The operations can include cache maintenance operations. The operations can further include cache maintenance operations, Advanced extensible Interface (AXI™) Coherence Extensions (ACE™) cache transactions, Advanced Microcontroller Bus Architecture (AMBA™) Coherence Hub Interface (CHI™) transactions, etc.

In embodiments, one or more processors 810 are coupled to the memory 812, wherein the one or more processors, when executing the instructions which are stored, are configured to: access a plurality of processor cores, wherein each processor of the plurality of processor cores includes a shared local cache, and wherein the shared local cache supports snoop operations; couple a snoop queue to the plurality of processor cores, wherein the snoop queue is shared among the plurality of processor cores; receive two or more snoop operations for the shared local cache, wherein the two or more snoop operations point to a common cache-line physical address within the shared local cache, and wherein the two or more snoop operations are enqueued in the snoop queue; generate a snoop response to a first snoop operation of the two or more snoop operations; and prevent a cache eviction operation from completing, based on the snoop response being completed with a positive cache-line physical address comparison, wherein the cache-line physical address comparison comprises a partial cache-line physical address comparison.

The system 800 can include an accessing component 820. The accessing component 820 can access a plurality of processor cores. The processor cores can be accessed within one or more ICs or chips, FPGAs, ASICs, etc. In embodiments, the processor cores can include RISC-V™ processor cores. Each processor of the plurality of processor cores includes a shared local cache. Each processor of the plurality of processor cores includes a local cache. The local cache that can be coupled to each processor, can be colocated with its associated processor core, can be accessible by the processor core, and so on. In embodiments, the shared local cache supports snoop operations. The snoop operations can point to one or more cache-line physical addresses. The cache-line physical addresses pointed to by the snoop operations can include substantially similar addresses or substantially dissimilar addresses. In embodiments, the plurality of processor cores can implement special cache coherency operations. The cache coherency operations can include maintenance operations such as cache maintenance operations (CMOs). The cache coherency operations can include a cache line zeroing operation, a cache line cleaning operation, a cache line flushing operation, a cache line invalidating operation, and so on. In embodiments, the CMO comprises a cache block operation (CBO) CLEAN instruction.

The plurality of processor cores and coupled local caches can include a coherency domain. The coherency can include coherency between the common memory and cache memory, such as level 1 (L1) cache memory. L1 cache memory can include local cache coupled to groupings of two or more processor cores. The coherency between the common memory and one or more local cache memories can be accomplished using cache maintenance operations (CMOs), described previously. In embodiments, two or more processor cores within the plurality of processor cores can generate read operations for a common memory structure coupled to the plurality of processor cores. The read operations for the common memory can occur based on cache misses to local cache, thereby requiring the read operations to be generated for the common memory. In embodiments, each processor of the plurality of processor cores can access a common memory structure. The access to the common memory structure can be accomplished through a coherent network-on-chip. The common memory can include on-chip memory, off-chip memory, etc. The coherent network-on-chip comprises a global coherency.

The system 800 can include a coupling component 830. The coupling component 830 can couple a snoop queue to the plurality of processor cores. The snoop queue can store snoop operations generated by one or more processors within the plurality of processor cores. The snoop queue can store the snoop operations as the operations are generated, an ordered set of snoop operations, and so on. The snoop queue is shared among the plurality of processor cores. As data is processed by the one or more processor cores, data within a cache such as a shared local cache can be updated and become “dirty”. The dirty data within the shared local cache differs from the data in a memory such as a shared system memory from which the data in the shared local cache was loaded. Thus, the data in the shared system memory must be updated to reflect the changes to the data in the shared local memory. Further, other local copies of the data from the shared system memory must be updated. However, the versions of the data in the shared system memory and the versions of the copies of the data in other shared local caches may still be required by other processes. Thus, snoop operations can be generated to determine whether memory access operations such as memory load and memory store operations access the same physical address in storage. The snoop operations can be used to control memory access race conditions such as read-after-write, write-before read, and so on. Prior to committing the changed or dirty data to memory, cache lines associated with the dirty data can be sent to an eject buffer prior to writing to storage such as shared system memory. In embodiments, the evict buffer enables delayed writes. The delayed writes can include writes initiated by a processor core to a local cache such as an L1 cache, writes to a shared L2 cache such as a hierarchical cache, writes to a shared system memory, and so on.

The system 800 can include a receiving component 840. The receiving component 840 can receive two or more snoop operations for the shared local cache. Recall that a snoop operation can be associated with a memory access operation such as a memory load (read) operation or a memory store (write) operation. The two or more snoop operations point to a common cache-line physical address within the shared local cache. That is, two or more memory access operations can point to a substantially similar physical address, thereby causing a potential memory race condition. Having received the snoop operations, the two or more snoop operations are enqueued in the snoop queue. The snoop operations can be issued from the snoop queue to determine any impacts to data integrity based on the memory access operations that generated the snoop operations. In a usage example, two snoop operations associated with memory load operations access a substantially similar cache-line physical address. While the same address is accessed, the load operations do not change contents of the cache line so ordering of the read operations is not critical. In a second usage example, one of the snoop operations can be a load operation and the other snoop operation can be a store operation. Because the store operation changes the cache-line contents, the ordering of the load and the store operation can be critical.

A snoop operation can include notifying a memory system, hierarchical cache, other shared caches, and so on that data such as a cache line has been modified. The snoop operation can include checking where there are other write requests that target a same address with storage such as the shared system memory. The snoop operation can include a global snoop operation. In embodiments, the global snoop operation can be initiated from an agent within a globally coherent system. The agent can include a process that intends to perform a write operation that changes a local copy of data in a local cache. Note that a snoop operation can be used to determine whether more than one operation needs to access a given physical address such as a cache-line physical address. The address can be present in a local cache associated with each of one or more cores, in a memory system, and so on. Since some operations such as a cache line operation can read contents of a cache line, modify a cache line, clear a cache line, etc., the order of the operations is critical to ensure correct processing of the cache line. A snoop operation can determine whether an address such as a load or a store address is present in one or more local caches, a hierarchical cache, etc. The snoop operation can be used to determine a proper order of execution of operations. Embodiments can include postponing a pending operation based on a snoop bit or a snoop active field being set. A snoop bit being set can indicate that another snoop operation is being performed. The snoop operation and the other snoop operations can include snoop operations enqueued in a snoop queue. Executing a pending operation could change data required by the operation that initiated the snoop operation. In other embodiments, the performing the cache line operation can be further based on one or more values in the snoop active field. The one or more values can include a valid bit. The one or more values in the snoop active field can indicate a snoop precedence, a snoop priority, a snoop order, etc. The snoop valid bit can be associated with a directory such as a snoop directory.

Discussed previously, in embodiments, the special cache coherency operation that was identified can include a cache maintenance operation (CMO). A cache maintenance operation can accomplish coherency of cache contents among local caches, a shared cache, system memory, and so on. In embodiments, the CMO can include a cache block operation (CBO) CLEAN instruction. A cache clean instruction can “clean” out dirty data. In embodiments, the special cache coherency operation that was identified can cause dirty data to be written into the evict buffer. The dirty data can be written from the evict buffer to memory such as the shared system memory at an appropriate time. The cache clean instruction can further clear any bit (e.g., “dirty bits”) that indicate that data is dirty from having been changed.

The system 800 can include a generating component 850. The generating component 850 can generate a snoop response to a first snoop operation of the two or more snoop operations. The snoop response can include a positive response or a negative response. The response can be based on a match of two or more snoop operations pointing to a common cache-line physical address within the shared local cache. The match can include a partial match. In embodiments, the partial cache-line physical address comparison can be performed between a cache-line aligned physical address of the cache eviction operation and all cache-line aligned physical addresses of outstanding snoop entries in the snoop queue. A positive match can indicate that the two or more snoop operations point to a common cache-line physical address, while a negative match can indicate that the two or more snoop operations point to different cache-line physical addresses. In embodiments, the partial cache-line physical address comparison can be based on a cache-line physical address couplet. The couplet can comprise fewer bits than the cache-line physical address. In embodiments, the cache-line physical address couplet can include a set-index field concatenated to a set-way field.

The system 800 can include a preventing component 860. The preventing component 860 can prevent a cache eviction operation from completing, based on the snoop response being completed with a positive cache-line physical address comparison. A positive cache-line physical address comparison indicates a common cache-line physical address targeted by two or more snoop operations in the snoop queue. Conversely, a negative cache-line physical address comparison indicates different cache-line physical addresses targeted by two or more snoop operations in the snoop queue. When the snoop operations point to a common physical address, the positive result can indicate that the data at the common address within the shared cache is required by additional snoop operations. If the snoop operations point to substantially different cache physical addresses, then data at the different address can be no longer required and can be evicted from the cache. Eviction from the cache can include writing dirty or changed data from the shared local cache to a shared common memory, to other caches, and so on.

The cache-line physical address comparison comprises a partial cache-line physical address comparison. The partial cache-line physical address comparison can be based on a quantity of address bits such as address most significant bits. The partial address comparison can be based on directory fields, flags, tags, and so on. In embodiments, the partial cache-line physical address comparison can be performed between a cache-line aligned physical address of the cache eviction operation and all cache-line aligned physical addresses of outstanding snoop entries in the snoop queue. Other bits can be associated with snoop operations. In embodiments, a directory can include a snoop bit for each of the snoop entries. The snoop bit can be used to indicate a status of a snoop operation, whether other snoop operations remain in the snoop queue, and so on. In embodiments, the snoop bit can be set based on a pending cache-line snoop operation in the snoop queue. Various techniques can be used for clearing a snoop bit. In other embodiments, the snoop bit can be cleared based on a last snoop replay for a pending cache-line snoop operation in the snoop queue.

Noted above, a cache evict operation can be allowed to complete. Embodiments can include allowing the cache eviction operation to complete based on the snoop response being completed with a negative cache-line physical address comparison. The negative cache-line physical address comparison can result from two or more snoop operations in the snoop addressing different cache-line physical addresses, completing execution of the last snoop operation in the snoop queue, and so on. The negative result can indicate other snoop operation status. In embodiments, the negative cache-line physical address comparison can indicate an absence of in-flight snoop requests for the cache-line physical address. In-flight snoop requests can include snoop requests from other processor cores within a compute coherency block.

Further embodiments can include allowing the cache eviction operation to complete based on the common cache-line physical address being overwritten in the shared local cache. The completing the eviction operation can include writing the overwritten or dirty data in the shared local cache out to the shared common memory, to other shared cache memories, and so on. The overwriting can also result from bringing a new cache-line in from the shared common memory, updating a local copy of a cache-line in the local cache, and so on. In embodiments, the overwriting can be performed by an evict fill operation. The evict fill operation can result from a cache to the shared local cache. The evict fill operation can also set or reset bits or flags pertaining to the cache line associated with the evict fill operation. In embodiments, the evict fill operation can clear a valid bit in a directory.

Discussed previously, the cache-line physical address comparison can be accomplished using a variety of techniques such as a full address comparison, a partial address comparison, and so on. In embodiments, the partial cache-line physical address comparison can be based on a cache-line physical address couplet. The physical address couplet can include one or more of bits, flags, fields, and the like. In embodiments, the cache-line physical address couplet can include a set-index field concatenated to a set-way field. An address couplet can also be associated with a snoop request. Further embodiments can include comparing the cache-line physical address couplet to a snoop request physical address couplet. In embodiments, the cache-line physical address couplet can include a constant value for a cache line that is being snooped. The timing of the comparison of a cache-line physical address couplet to a snoop request physical address couplet can be critical to enabling a cache eviction operation or preventing a cache eviction operation. In embodiments, the comparing the cache-line physical address couplet to a snoop request physical address couplet can occur prior to the preventing.

In embodiments, the cache line operation can include a cache maintenance operation. A cache maintenance operation can be performed to maintain cache coherency. The cache coherency maintenance can be applied to a local cache coupled to a core, a shared cache coupled to two or more processor cores, one or more local caches, a hierarchical cache, a last level cache, a common memory, a memory system, and so on. Various cache maintenance operations (CMOs) can be performed. In embodiments, the cache maintenance operation can include cache block operations. The cache block operations can include a subset of maintenance operations. The cache block operations can update a state associated with all caches such as the local caches. The updated state can include a specific state with respect to the hierarchical cache, the last level cache, the common memory, etc. In embodiments, the cache block operations can include a cache line zeroing operation, a cache line cleaning operation, a cache line flushing operation, and a cache line invalidating operation. The cache line operations can include making all copies of a cache line consistent with a cache line from the common memory while leaving the consistent copies in the local caches, flushing “dirty” data for a cache line then invalidating copies of the flushed, dirty data, invalidating copies of a cache line without flushing dirty data to the common memory, and so on. In other embodiments, the cache line operation can include a coherent read operation. A coherent read operation can enable a read of data to be written to a memory address in a single cycle. That the new data can be read (e.g., a “flow through”) during an operation such as a read-during-write operation. In other embodiments, the coherent read operation can include a ReadShared operation and a ReadUnique operation.

A cache maintenance operation generates cache coherency transactions between global coherency and compute coherency blocks. The global coherency can include coherency between the common memory and local caches, among local caches, and so on. The local coherency can include coherency between a local cache and local processors coupled to the local cache. Maintaining the local cache coherency and the global coherency is complicated by the use of a plurality of local caches. Recall that a local cache can be coupled to a grouping of two or more processors. While the plurality of local caches can enhance operation processing by the groupings of processors, there can exist more than one dirty copy of one or more cache lines present in any given local cache. Thus, the maintaining of the coherency of the contents of the caches and the system memory can be carefully orchestrated to ensure that valid data is not overwritten, stale data is not used, etc. The cache maintenance operations can be enabled by an interconnect. In embodiments, the grouping of two or more processor cores and the shared local cache can be interconnected to the grouping of two or more additional processor cores and the shared additional local cache using the coherent network-on-chip. In embodiments, the system 800 implements cache management through implementation of semiconductor logic. One or more processors can execute instructions which are stored to generate semiconductor logic to: access a plurality of processor cores, wherein each processor of the plurality of processor cores accesses a common memory through a coherent network-on-chip, and wherein the coherent network-on-chip comprises a global coherency; couple a local cache to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency; and perform a cache maintenance operation in the grouping of two or more processor cores and the shared local cache, wherein the cache maintenance operation generates cache coherency transactions between the global coherency and the local coherency.

The transferring between a compute coherency block cache (CCB$) and a bus interface unit can compensate for mismatches in bit widths, transfer rates, access times, etc. between the CCB$ and the bus interface unit. In embodiments, cache lines can be stored in a bus interface unit cache prior to commitment to the common memory structure. Once transferred to the BIU, the BIU can handle the transferring of cache lines such as evicted cache lines to the common memory based on the snoop responses. The transferring can include transferring the cache line incrementally or as a whole. The snoop responses can be used to determine an order in which the cache lines can be committed to the common memory. In other embodiments, cache lines can be stored in a bus interface unit cache pending a cache line fill from the common memory structure. The cache lines can be fetched incrementally or as a whole from the common memory and stored in the BIU cache. In other embodiments the ordering and the mapping can include a common ordering point for coherency management. The common ordering point can enable coherency management between a local cache and processor cores coupled to the local cache, between local caches, between local caches and the common memory, and the like. In further embodiments, the common ordering point can include a compute coherency block coupled to the plurality of processor cores. The compute coherency block can be colocated with the processor cores within an integrated circuit, located within one or more further integrated circuits, etc.

The system 800 can include a computer program product embodied in a non-transitory computer readable medium for cache management, the computer program product comprising code which causes one or more processors to perform operations of: accessing a plurality of processor cores, wherein each processor of the plurality of processor cores includes a shared local cache, and wherein the shared local cache supports snoop operations; coupling a snoop queue to the plurality of processor cores, wherein the snoop queue is shared among the plurality of processor cores; receiving two or more snoop operations for the shared local cache, wherein the two or more snoop operations point to a common cache-line physical address within the shared local cache, and wherein the two or more snoop operations are enqueued in the snoop queue; generating a snoop response to a first snoop operation of the two or more snoop operations; and preventing a cache eviction operation from completing, based on the snoop response being completed with a positive cache-line physical address comparison, wherein the cache-line physical address comparison comprises a partial cache-line physical address comparison.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Disclosed embodiments are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for cache management comprising:
accessing a plurality of processor cores, wherein each processor of the plurality of processor cores includes a shared local cache, and wherein the shared local cache supports snoop operations;
coupling a snoop queue to the plurality of processor cores, wherein the snoop queue is shared among the plurality of processor cores;
receiving two or more snoop operations for the shared local cache, wherein the two or more snoop operations point to a common cache-line physical address within the shared local cache, and wherein the two or more snoop operations are enqueued in the snoop queue;
generating a snoop response to a first snoop operation of the two or more snoop operations; and
preventing a cache eviction operation from completing, based on the snoop response being completed with a positive cache-line physical address comparison, wherein the cache-line physical address comparison comprises a partial cache-line physical address comparison.

2. The method of claim 1 wherein the partial cache-line physical address comparison is performed between a cache-line aligned physical address of the cache eviction operation and all cache-line aligned physical addresses of outstanding snoop entries in the snoop queue.

3. The method of claim 2 wherein a directory includes a snoop bit for each of the snoop entries.

4. The method of claim 3 wherein the snoop bit is set based on a pending cache-line snoop operation in the snoop queue.

5. The method of claim 3 wherein the snoop bit is cleared based on a last snoop replay for a pending cache-line snoop operation in the snoop queue.

6. The method of claim 2 further comprising allowing the cache eviction operation to complete, based on the common cache-line physical address being overwritten in the shared local cache.

7. The method of claim 6 wherein the overwriting is performed by an evict fill operation.

8. The method of claim 7 wherein the evict fill operation clears a valid bit in a directory.

9. The method of claim 1 further comprising allowing the cache eviction operation to complete, based on the snoop response being completed with a negative cache-line physical address comparison.

10. The method of claim 9 wherein the negative cache-line physical address comparison indicates an absence of in-flight snoop requests for the cache-line physical address.

11. The method of claim 1 wherein the partial cache-line physical address comparison is based on a cache-line physical address couplet.

12. The method of claim 11 wherein the cache-line physical address couplet comprises a set-index field concatenated to a set-way field.

13. The method of claim 11 further comprising comparing the cache-line physical address couplet to a snoop request physical address couplet.

14. The method of claim 13 wherein the comparing the cache-line physical address couplet to a snoop request physical address couplet occurs prior to the preventing.

15. The method of claim 11 wherein the cache-line physical address couplet comprises a constant value for a cache line that is being snooped.

16. The method of claim 1 wherein the shared local cache is coupled to a grouping of two or more processor cores of the plurality of processor cores.

17. The method of claim 16 wherein the shared local cache is shared among the two or more processor cores.

18. The method of claim 17 wherein the grouping of two or more processor cores and the shared local cache operates using local coherency.

19. The method of claim 18 wherein the local coherency is distinct from a global coherency.

20. The method of claim 19 further comprising performing a cache maintenance operation in the grouping of two or more processor cores and the shared local cache.

21. The method of claim 20 wherein the cache maintenance operation generates cache coherency transactions between the global coherency and the local coherency.

22. The method of claim 19 further comprising performing a global snoop operation on the shared local cache.

23. A computer program product embodied in a non-transitory computer readable medium for cache management, the computer program product comprising code which causes one or more processors to generate semiconductor logic for:
accessing a plurality of processor cores, wherein each processor of the plurality of processor cores includes a shared local cache, and wherein the shared local cache supports snoop operations;
coupling a snoop queue to the plurality of processor cores, wherein the snoop queue is shared among the plurality of processor cores;
receiving two or more snoop operations for the shared local cache, wherein the two or more snoop operations point to a common cache-line physical address within the shared local cache, and wherein the two or more snoop operations are enqueued in the snoop queue;
generating a snoop response to a first snoop operation of the two or more snoop operations; and
preventing a cache eviction operation from completing, based on the snoop response being completed with a positive cache-line physical address comparison, wherein the cache-line physical address comparison comprises a partial cache-line physical address comparison.

24. A computer system for cache management comprising:
a memory which stores instructions;
one or more processors coupled to the memory wherein the one or more processors, when executing the instructions which are stored, are configured to:
access a plurality of processor cores, wherein each processor of the plurality of processor cores includes a shared local cache, and wherein the shared local cache supports snoop operations;
couple a snoop queue to the plurality of processor cores, wherein the snoop queue is shared among the plurality of processor cores;
receive two or more snoop operations for the shared local cache, wherein the two or more snoop operations point to a common cache-line physical address within the shared local cache, and wherein the two or more snoop operations are enqueued in the snoop queue;
generate a snoop response to a first snoop operation of the two or more snoop operations; and
prevent a cache eviction operation from completing, based on the snoop response being completed with a positive cache-line physical address comparison, wherein the cache-line physical address comparison comprises a partial cache-line physical address comparison.
